(19) United States
(12) Patent Application Publication
(10) Pub. No.: US 2024/0229808 A9
(43) Pub. Date: Jul. 11, 2024

(54) DEVICE AND METHOD FOR CONVERTING RECIPROCATING MOTION INTO CONTINUOUS ROTATION, AND APPLICATION

(71) Applicant: Foshan Shenfeng Aviation Technology Co., Ltd., Foshan, Guangdong (CN)

(72) Inventor: Zhicheng WANG, Foshan, Guangdong (CN)

(21) Appl. No.: 17/769,961

(22) PCT Filed: Aug. 27, 2021
(86) PCT No.: PCT/CN2021/115076

§ 371 Date: Jun. 2, 2022

(30) Foreign Application Priority Data
Nov. 26, 2020 (CN) 202011342501.X
Aug. 27, 2021 (WO) PCT/CN2021/115076

(51) Int. Cl. F04D 25/00; A63B 21/008; B63G 8/08; B64C 27/32; F04D 13/00

(52) U.S. Cl. CPC F04D 25/00; A63B 21/0084; B63G 8/08; B64C 27/32; F04D 13/00

(57) ABSTRACT

The present disclosure discloses a device and a method for converting reciprocating motion into continuous rotation, and application includes: a central shaft and rotating discs, each rotating disc is connected to the central shaft through a bearing, the rotating disc is arranged concentrically with the bearing, wings are arranged on a circumference of rotating disc, upper wing surfaces of the wings are of convex structures. According to the device for converting reciprocating motion into continuous rotation of the present disclosure, the rotating directions of the wings can be kept unchanged all the time during the reciprocating motion of the device by using airfoil structures of the wings in the device and limiting mounting angles of the wings, so as to obtain a continuous lifting force with a constant direction.

### TECHNICAL FIELD

The present disclosure relates to the technical field of mechanical equipment, more specifically, to a device and a method for converting reciprocating motion into continuous rotation, and application.

### BACKGROUND ART

A fixed wing aircraft is relatively efficient, but it needs relatively long runways during both taking off and landing, and it cannot hover, and has poor mobility and low safety. A helicopter can lift vertically, but has relatively low efficiency, complex structure, great operation difficulty, and low safety.

Therefore, it is an urgent problem for those skilled in the art to provide a device for converting reciprocating motion into continuous rotation, which is reasonable in design, simple in structure, convenient to operate, safe and reliable, and high in efficiency, and can provide a continuous lifting force for an aircraft.

### SUMMARY

The present disclosure aims to solve one of the above-mentioned technical problems in the prior art at least to a certain extent. Therefore, one objective of the present disclosure is to provide a device for converting reciprocating motion into continuous rotation, which is reasonable in design, simple in structure, convenient to operate, safe and reliable, and high in efficiency, and can provide a continuous lifting force for an aircraft.

A second objective of the present disclosure is to provide a method for converting reciprocating motion into continuous rotation by using the device.

A third objective of the present disclosure is to provide an aircraft with the device for converting reciprocating motion into continuous rotation.

Another objective of the present disclosure is to provide an underwater machine with the device for converting reciprocating motion into continuous rotation.

Yet another objective of the present disclosure is to provide sports equipment with the device for converting reciprocating motion into continuous rotation.

To achieve the first objective above, the present disclosure adopts the following technical solution.

A device for converting reciprocating motion into continuous rotation includes: a central shaft, where bearings rotatably connected with same are arranged on the central shaft;
rotating discs, where each rotating disc is mounted on a side wall of a circumference of the bearing, and the rotating disc is arranged concentrically with the bearing; wings are mounted on a circumferential surface of the rotating disc; one end of each wing is mounted on the circumferential surface of a rotating disc; the spanwise direction of the wing is in the same direction of the radial direction of the rotating disc; an upper wing surface of the wing is arc-shaped and protrudes upwards; a trailing edge of the wing is thinner than a leading edge; there are a plurality of wings; the plurality of wings are uniformly arranged around the rotating disc; and the directions of the leading edges of the plurality of wings are consistent; and a mounting angle at which the wing is mounted on the rotating disc is between −2° and 4°. The mounting angle is an included angle between a chord line of the wing and a rotating plane of the rotating disc. The mounting angle is positive when the leading edge of the wing is higher than the tailing edge of the wing, and the mounting angle is negative when the leading edge of the wing is lower than the tailing edge of the wing.

It can be unknown from the above-mentioned technical solution that, compared with the solution in the prior art, the present disclosure provides a device for converting reciprocating motion into continuous rotation. The rotating directions of the wings can be kept unchanged all the time during reciprocating linear motion of the device along the axial direction of the central shaft by using airfoil structures of the wings in the device and limiting the mounting angles of the wings, i.e., the wings are kept rotating in the rotation direction that the leading edges of the wings are forward and the tailing edges of the wings are rearward all the time. When an absolute value of the mounting angle is relatively large, in order to facilitate starting the device, the wing may be prodded to rotate in the direction of the leading edge in advance. The device for converting reciprocating motion into continuous rotation of the present disclosure is not only reasonable in design and simple in structure, but also convenient to operate, easy to control, and high in efficiency. The device can be used as a mechanical transmission mechanism to convert reciprocating linear motion into circular rotation, and can also provide a continuous lifting force for an aircraft or provide continuous rotation for an underwater machine, so it has a good application prospect.

Further, the model of the wing uses one of an NACA2412 airfoil or an NACA0012 airfoil.

If the central shaft of the above-mentioned device is placed vertically, the reciprocating motion of the device is up-and-down motion, and if the speed of downward motion is higher than that of upward motion, the beneficial effects achieved by adopting the above-mentioned technical solution are that the lift drag of the wings of the device is relatively large during continuous rotation, and a relatively great lifting force can be produced continuously during rotation. In addition, the windward area of the wings can be reduced during rotation of the wings in the device, so as to reduce pressure drag, and prevent air flow on the wings from premature separation when passing through the upper wing surfaces of the wings, resulting in the loss of lifting force. Thus, the wings have good aerodynamic characteristics.

Further, there are three wings. The three wings are arranged at 120° to each other. The directions of the leading edges of the three wings are consistent.

The beneficial effects achieved by adopting the technical solution are that the structure of the device can be more reasonable. By the arrangement of the three wings, the device can produce a relatively great lifting force continuously during continuous rotation on the basis of not increasing the manufacturing cost.

Further, there are two rotating discs, and there are two bearings arranged corresponding to the rotating discs. The two rotating discs are connected to the central shaft through the bearings. The two rotating discs are arranged in parallel, and the directions of the leading edges of the wings respectively arranged on the two rotating discs are opposite.

The beneficial effects achieved by adopting the above-mentioned technical solution are that the design of double layers of rotor wings not only makes the structure of the device more compact, but also makes the device produce a greater lifting force under the action of the rotation of the double layers of wings. Meanwhile, the arrangement of opposite directions of the leading edges of the double layers of wings enables the wings to counteract a torque force acting on the central shaft due to friction between the bearings and the central shaft resulting from the rotation of the wings during rotation.

A second aspect of the present disclosure further provides a method for converting reciprocating motion into continuous rotation by using the above-mentioned device, including the following steps:
(1) placing the device in a gas or a liquid, driving one end of a central shaft in the device by using power, so that the device moves in a straight line in one direction along the axial direction of the central shaft, at this moment, the wings move due to the action of the gas or the liquid on the wings, the wings on the device drive the rotating discs to rotate, and a rotating direction is the direction in which leading edges of the wings are forward and tailing edges of the wings are rearward; and
(2) driving the other end of the central shaft of the device, so that the device moves in a straight line in the direction opposite to that in (1), at this moment, the wings on the device drive the rotating discs to continue rotating, and the rotating direction is the direction in which the leading edges of the wings are forward and the tailing edges of the wings are rearward.

Further, in steps (1) and (2), the rotation directions of the wings of the device are the same. When the convexity of upper and lower surfaces of the wing is asymmetric, or the reciprocating speed of linear motion is different, or the mounting angle of the wing is greater than zero, the device can provide a lifting direction in a constant direction.

According to the method for converting reciprocating motion into continuous rotation of the present disclosure, the device can produce a continuous lifting force and is simple in structure and high in efficiency by using the device for converting reciprocating motion into continuous rotation according to the first aspect of the present disclosure. By the method using the structure, the device can convert reciprocating motion into continuous rotation of the wings, so as to produce a lifting force or a thrust in a constant direction.

A third aspect of the present disclosure further provides an aircraft. The aircraft includes the device for converting reciprocating motion into continuous rotation according to the first aspect of the present disclosure.

According to the aircraft of the present disclosure, the aircraft can produce a continuous upward lifting force during taking off, landing, and cruising by using the device for converting reciprocating motion into continuous rotation according to the first aspect of the present disclosure, and the device is mounted on each of both sides of the aircraft or one or more devices are mounted above a body of the aircraft to provide continuous and basically stable lifting force for smooth flight of the aircraft in the air, so as to efficiently save the energy consumption of an engine. Therefore, the aircraft is simpler in structure, convenient to operate, and easy to control, and the operation cost of the aircraft is reduced.

A fourth aspect of the present disclosure is to provide an underwater machine. The underwater machine includes the device for converting reciprocating motion into continuous rotation according to the first aspect of the present disclosure.

According to the underwater machine of the present disclosure, the underwater machine can produce an upward lifting force or can be used for generating electricity during traveling by using the device for converting reciprocating motion into continuous rotation according to the first aspect of the present disclosure.

A fifth aspect of the present disclosure further provides a mechanical transmission mechanism.

According to the mechanical transmission mechanism of the present disclosure, the device for converting reciprocating motion into continuous rotation according to the first aspect of the present disclosure is applied to the mechanical transmission mechanism. Water or oil is used as a medium, and wings move in the water or oil in a closed container, which has an effect of converting input power of the reciprocating linear motion into output power of circular motion. The mechanical transmission mechanism is simpler and more effective than a crankshaft connecting rod mechanism.

A sixth aspect of the present disclosure further provides sports equipment.

According to the sports equipment of the present disclosure, the device for converting reciprocating motion into continuous rotation according to the first aspect of the present disclosure is applied to the sports equipment. Water or oil is used as a medium, and wings of the device are placed in the water or oil, and the wings are rotated by pushing and pushing a central shaft with hands or pedaling the central shaft with feet, which can not only realize body exercising, but also be entertainment and ornamental value. In the solution, the wings adopt biconvex symmetrical airfoils, such as NACA0012 airfoils. The mounting angle of the wing is zero, which is more convenient to drive and the rotation effect will be better.

### BRIEF DESCRIPTION OF THE DRAWINGS

FIG. 1 is a schematic structural diagram of a device for converting reciprocating motion into continuous rotation provided by the present disclosure;

FIG. 2 is a sectional view of a wing in the device for converting reciprocating motion into continuous rotation provided by the present disclosure; in FIG. 2, a left end is a front edge of the wing, and a right end is a rear edge of the wing; and

FIG. 3 is a schematic structural diagram of a device including double layers of fins and used for converting reciprocating motion into continuous rotation provided by the present disclosure.

Reference signs in the drawings: 1—central shaft, 2—bearing, 3—rotating disc, 4—wing, 41—upper wing surface, and 42—lower wing surface.

### DETAILED DESCRIPTION OF THE EMBODIMENTS

Embodiments of the present disclosure are described in detail below, and the examples of the embodiments are illustrated in the accompanying drawings. The embodiments described below with reference to the drawings are intended to be illustrative of the present disclosure and are not to be construed as a limitation to the present disclosure.

In the description of the present disclosure, it is to be understood that orientations or positional relationships indicated by the terms “upper”, “lower”, “front”, “back”, “left”, “right”, “vertical”, “horizontal”, “top”, “bottom”, “inside”, “outside”, and the like are the orientations or positional relationships shown on the basis of the accompanying drawings, and are merely for facilitating describing the present disclosure and simplifying the description, rather than indicating or implying that the devices or elements must have particular orientations, and be constructed and operated in particular orientations. Thus, it cannot be construed as a limitation to the present disclosure.

The present disclosure discloses a device for converting reciprocating motion into continuous rotation, including:
a central shaft 1, where bearings 2 rotatably connected with same are arranged on the central shaft 1;
rotating discs 3, where each rotating disc 3 is fixedly connected to a side wall of a circumference of the bearing 2, and the rotating disc 3 is arranged concentrically with the bearing 2; wings 4 are arranged on the side wall of the circumference of the rotating disc 3; one end of each wing 4 is arranged on a circumferential surface of the rotating disc 3 and is fixedly connected to the rotating disc 3; the wings 4 are airfoils with upward convex arc-shaped upper wing surfaces 41; and leading edges of the wings 4 are thick, and tailing edges are sharp. The mounting angle at which the wing 4 is mounted on the rotating disc 3 is between −2° and 4°. The mounting angle is an included angle between a chord line of the wing 4 and a rotating plane of the rotating disc 3. The mounting angle is positive when the leading edge of the wing 4 is higher than the tailing edge of the wing 4, and the mounting angle is negative when the leading edge of the wing 4 is lower than the tailing edge of the wing 4.

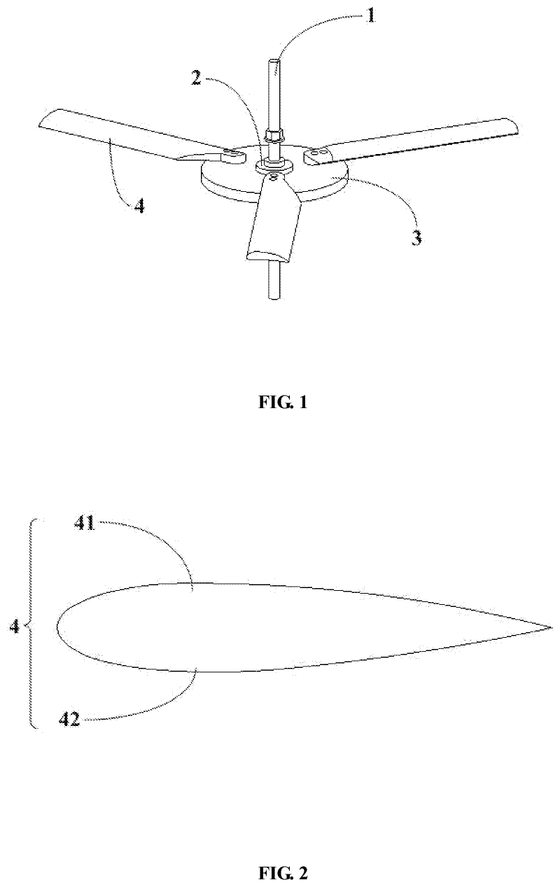

As shown in FIG. 1, according to an optional embodiment of the present disclosure, there are three wings 4. The three wings 4 are arranged at 120° to each other. The directions of the leading edges of the three wings 4 are consistent. Specifically, the model of the wings 4 is NACA2412 airfoils, so that the structure of the device can be more reasonable, and the device can ensure that the wings can continuously produce a great lifting force during continuous rotation on the basis of not increasing the production cost.

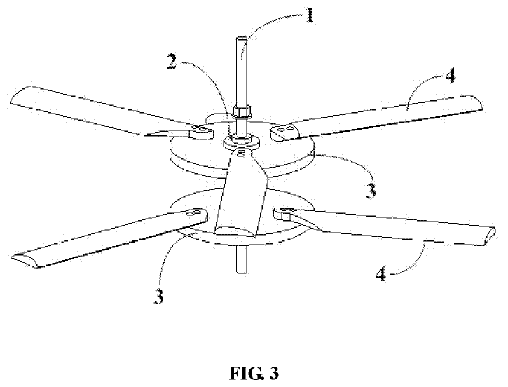

As shown in FIG. 3, according to an optional embodiment of the present disclosure, there are two rotating discs 3, and there are two bearings 2 arranged corresponding to the two rotating discs 3. The two bearings 2 are uniformly arranged on the central shaft 1. The two rotating discs 3 are arranged in parallel, and the directions of the leading edges of the wings 4 respectively arranged on the two rotating discs 3 are opposite. The design of double layers of rotor wings not only makes the structure of the device more compact, but also makes the device be subjected to a greater lifting force under the action of the rotation of the double layers of wings. Meanwhile, the arrangement of opposite directions of the leading edges of the double layers of wings enables the wings to counteract a torque force acting on the central shaft due to the rotation of the wings during the rotation of the wings.

According to the device for converting reciprocating motion into continuous rotation, the rotation directions of the wings can be kept unchanged all the time during reciprocating linear motion of the device by using airfoil structures of the wings in the device and limiting the mounting angles, i.e., wings are kept rotating in the rotation direction that the leading edges of the wings are forward and the tailing edges of the wings are rearward all the time, so as to provide a lifting force at a constant direction for the device. When an absolute value of the mounting angle is greater than 1°, in order to facilitate starting the device, the wing may be prodded to rotate in the direction of the leading edge in advance. The device for converting reciprocating motion into continuous rotation of the present disclosure is not only reasonable in design and simple in structure, but also convenient to operate, easy to control, and high in efficiency. The device can provide a continuous lifting force for an aircraft or provide a continuous thrust for ship navigation, so it has a good application prospect.

A method for converting reciprocating motion into continuous rotation according to the above-mentioned embodiment of the present disclosure is described below. The method includes the following steps.
(1) One end of the central shaft in the device is pulled, so that the device moves in a straight line in one direction of the central shaft, and at this moment, the wings of the device move under the action of a medium (air or water) in an environment, and the wings on the device drive the rotating discs to rotate, where a rotating direction is the direction in which the leading edges of the wings are forward and the tailing edges of the wings are rearward.
(2) The other end of the central shaft in the device in (1) is pulled, so that the device moves in a straight line in the direction opposite to that in (1), and at this moment, the wings on the device drive the rotating disc to continuing rotating according to the direction in (1), i.e., the rotating direction is the direction in which the leading edges of the wings are forward and the tailing edges of the wings are rearward.

According to an optional embodiment of the present disclosure, in steps (1) and (2), the convexity of upper surface of the wing is greater than that of the lower surface of the wing. The reciprocating speed of linear motion is different. The downward linear motion is driven by power, the speed is relatively high; and the upward linear motion is a result of an action of the lifting force produced by high-speed rotation of the wings, so the upward speed is relatively low. The rotation directions of the wings of the device are the same, so that the device produces an upward lifting force.

According to the method for converting reciprocating motion into continuous rotation of the present disclosure, the device can structurally produce a continuous lifting force and is simple in structure and high in efficiency by using the device for converting reciprocating motion into continuous rotation according to the above-mentioned embodiment of the present disclosure. By the method using the structure, the device can convert reciprocating motion into continuous rotation of the wings, and can also produce a lifting force or a thrust in a constant direction.

The aircraft of the present disclosure is described below. The aircraft includes the device for converting reciprocating motion into continuous rotation according to the above-mentioned embodiment of the present disclosure.

The device for converting reciprocating motion into continuous rotation according to the above-mentioned embodiment of the present disclosure is mounted on each of the both sides of a body of the aircraft in the present embodiment. The above-mentioned devices are symmetrically arranged on both sides of the body, and the above-mentioned devices are connected with a power source. During the taking off of the aircraft, the above-mentioned devices perform the motion similar to a semi-rotation mechanism to an outer side along the aircraft, so that the above-mentioned devices perform rotation while performing revolution along the body of the aircraft. During the rotation, the wings rotate at a high speed, so that the aircraft is subjected to a continuous upward lifting force to drive the aircraft to take off from the earth. When the aircraft rises to the air for perform level flight, forward and rearward air flow are produced on both sides of the body of the aircraft, so as to drive the wings of the above-mentioned device to perform high-speed rotation, thereby producing a continuous upward lifting force for the aircraft. During landing of the aircraft, the above-mentioned devices drive the wings of the above-mentioned devices to rotate under the action of upward air flow, so as to provide an upward lifting force for the aircraft continuously, thereby keeping the aircraft landing smoothly.

According to the aircraft of the embodiment of the present disclosure, the aircraft can produce a continuous upward lifting force during taking off, level flight, and landing by using the device for converting reciprocating motion into continuous rotation according to the embodiment of a first aspect of the present disclosure. The device is mounted on each of both sides of the aircraft, so as to provide a continuous stable lifting force for smooth flight of the aircraft in the air, thereby effectively saving the energy consumption of an engine. The aircraft is simpler in structure, convenient to operate, and easy to control, and the operation cost of the aircraft is reduced.

An underwater machine of the present disclosure is described below. The underwater machine is a ship. The ship includes the device for converting reciprocating motion into continuous rotation according to the above-mentioned embodiment of the present disclosure.

The device for converting reciprocating motion into continuous rotation according to the above-mentioned embodiment of the present disclosure is mounted on each of both sides of a body of the aircraft in the present embodiment. The above-mentioned devices are symmetrically arranged on both sides of the body, and the above-mentioned devices are connected with a power source. During navigation of the aircraft, the above-mentioned devices is tilted outward at a certain degree to perform the motion similar to a semi-rotation device, so that the above-mentioned devices perform rotation while performing revolution along the body of a ship, and the wings rotate at a high speed during rotation, so that the ship is subjected to a continuous oblique upward thrust to drive the ship to travel at a high speed, and the body of the ship can be kept smooth during quick navigation.

According to the ship of the embodiment of the present disclosure, the ship can produce an upward and forward thrust during traveling by using the device for converting reciprocating motion into continuous rotation according to the first aspect of the present disclosure, and the device is mounted on each of both sides of the body of the ship to provide a stable thrust for keeping smooth operation of the ship, so as to effectively save the energy consumption of an engine. Therefore, the ship is simpler in structure, convenient to operate, and easy to control, and the operation cost of the ship is reduced.

According to the mechanical transmission mechanism of the embodiment of the present disclosure, the device for converting reciprocating motion into continuous rotation according to the first aspect of the embodiment the present disclosure is applied to the mechanical transmission mechanism. Water or oil is used as a medium, and wings move in the water or oil, which has an effect of converting input power of the reciprocating linear motion into output power of circular motion. The mechanical transmission mechanism is simpler and more effective than a gear train or a crankshaft connecting rod mechanism.

Sports equipment of the present disclosure is described below. The sports equipment includes the device for converting reciprocating motion into continuous rotation according to the above-mentioned embodiment of the present disclosure.

According to the sports equipment of the present disclosure, the device for converting reciprocating motion into continuous rotation according to the first aspect of the present disclosure is applied to the sports equipment. Water or oil is used as a medium, and wings of the device are placed in the water or oil, and the wings are rotated by pushing and pushing a central shaft with hands or pedaling the central shaft with feet, which can not only realize body exercising, but also be entertainment and ornamental value. In the solution, the wings adopt biconvex symmetrical airfoils, such as NACA0012 airfoils. The mounting angle of the wing is zero, which is more convenient to drive and the rotation effect will be better.

1. A device for converting reciprocating motion into continuous rotation, comprising: a central shaft (1) and at least one rotating disc (3), wherein each rotating disc (3) is connected to the central shaft (1) through a bearing (2); wherein the rotating disc (3) is arranged concentrically with the bearing (2); wherein a plurality of wings (4) are mounted on a circumference of the rotating disc (3); wherein the wings (4) extend radially from the rotating disc (3); wherein an upper wing surface (41) of the wing (4) is arc-shaped and protrudes upwards; wherein a trailing edge of the wing (4) is thinner than a leading edge; wherein the plurality of wings (4) are uniformly arranged around the rotating disc (3), wherein directions of the leading edges of the plurality of wings (4) are consistent; and wherein a mounting angle at which the wings (4) are mounted on the rotating disc (3) is between −2° and 4°.

2. The device for converting reciprocating motion into continuous rotation according to claim 1, comprising three wings (4); and wherein the three wings (4) are arranged at 120° to each other.

3. The device for converting reciprocating motion into continuous rotation according to claim 1, comprising two rotating discs (3); wherein two bearings (2) are arranged corresponding to the two rotating discs (3); wherein the two rotating discs (3) are arranged in parallel; and wherein the leading edges of the wings (4) respectively arranged on the two rotating discs (3) are in different directions.

4. A method for converting reciprocating motion into continuous rotation by using the device according to any one of claim 1, comprising the following steps:
(1) pulling one end of the central shaft in the device, so that the device moves in a straight line in one direction along the axis of the central shaft, and the wings on the device drives the rotating disc to rotate, wherein a rotating direction is the direction in which the leading edges of the wings are forward and the tailing edges of the wings are rearward; and
(2) pulling another end of the central shaft of the device in (1), so that the device moves in a straight line in the direction opposite to that in (1), and the wings on the device drive the rotating disc to rotate, wherein the rotating direction is the direction in which the leading edges of the wings are forward and the tailing edges of the wings are rearward.

5. The method for converting reciprocating motion into continuous rotation according to claim 4, wherein in steps (1) and (2), the rotating directions of the wings of the device are the same, and the device can generate a lifting force in a constant direction.

6. An aircraft, comprising the device for converting reciprocating motion into continuous rotation according to any one of claim 1.

7. An underwater machine, comprising the device for converting reciprocating motion into continuous rotation according to any one of claim 1.

8. A mechanical transmission mechanism, comprising the device for converting reciprocating motion into continuous rotation according to any one of claim 1.

9. Sports equipment, comprising the device for converting reciprocating motion into continuous rotation according to any one of claim 1.
